(19) United States
(12) Patent Application Publication
(10) Pub. No.: US 2025/0105708 A1
(43) Pub. Date: Mar. 27, 2025

(54) ELECTRIC MOTOR AND CONTROLLER ASSEMBLY

(71) Applicant: Hydro-Gear Limited Partnership, Sullivan, IL (US)

(72) Inventors: Nathan W. Bonny, Shelbyville, IL (US); Michael L. Bennett, Sullivan, IL (US); Shane A. Deters, Charleston, IL (US); Henry J. Hansen, Zionsville, IN (US); John Wesley Sawyer, VII, Whitestown, IN (US)

(21) Appl. No.: 18/892,364

(22) Filed: Sep. 21, 2024

Related U.S. Application Data
(60) Provisional application No. 63/606,482, filed on Dec. 5, 2023.
(60) Provisional application No. 63/596,148, filed on Nov. 3, 2023.
(60) Provisional application No. 63/584,435, filed on Sep. 21, 2023.

(51) Int. Cl. H02K 11/30; H02K 9/06; H02K 9/22; H02K 11/00

(52) U.S. Cl. CPC H02K 11/30; H02K 9/06; H02K 9/227; H02K 11/0094

(57) ABSTRACT

A versatile and compact design for an electric motor assembly is disclosed. The electric motor assembly may include a fan mounted on an end of an output through-shaft of an electric motor to cool both the electric motor and a motor controller. The motor controller may be bracket-mounted on the electric motor housing or integrated into the electric motor assembly and is electrically connected to the electric motor to deliver power and exchange CAN bus communication. A fan shroud may be mounted on a compartment cover that seals a first end of the electric motor assembly. This shroud-mounting compartment cover is interchangeable with a brake compartment cover of an electric brake assembly. When the fan and shroud are removed, an electric brake can be installed in the brake compartment.

### CROSS-REFERENCE

This application claims priority to U.S. Provisional Patent Application No. 63/606,482 filed on Dec. 5, 2023, U.S. Provisional Patent Application No. 63/596,148 filed on Nov. 3, 2023 and U.S. Provisional Patent Application No. 63/584,435 filed on Sep. 21, 2023. The contents of these applications are incorporated herein by reference in their entireties.

### BACKGROUND

This application relates to a versatile electric motor assembly that may be configured in various ways. An electric motor assembly in accordance with this invention may be used for applications such as an auxiliary drive on a vehicle or on estate maintenance equipment (e.g. vacuum or blower attachments), among other applications.

### SUMMARY

A versatile electric motor is disclosed herein. The electric motor can be configured in various ways depending on the requirements of specific applications. A first embodiment of the electric motor comprises a quiet-operation electric brake with a brake rotor mounted on an output shaft of the electric motor (also referred to herein as a motor output shaft, or simply as a motor shaft). In a second embodiment of the electric motor, brake components are removed and a brake compartment cover is replaced by an interchangeable shroud-mounting compartment cover comprising a shaft seal and slotted arms for mounting a fan shroud. In this embodiment, a fan is mounted on an output shaft of the electric motor to cool the electric motor. In a third embodiment, a motor controller is bracket-mounted on an electric motor that is substantially the same as the electric motor of the second embodiment such that the fan helps to cool both the electric motor and the controller. A fourth embodiment of the electric motor is a low-cost motor without brake, fan or bracket-mounted controller. This motor may be configured with or without a Hall effect board, and can include a less expensive electrical connector when configured without the Hall effect board. In a fifth embodiment, brackets for mounting a motor controller are integrally formed on a compartment cover and motor mounting base at opposite ends of the electric motor. The compartment cover includes features for mounting a fan shroud, and a protected fan helps to cool both the electric motor and the controller as in the third embodiment. A sixth embodiment of the electric motor includes a shroud-mounting compartment cover and fan shroud similar to that of the second embodiment. This configuration also includes an integrated motor controller with stacked circuit boards disposed about the rotational axis of the motor output shaft, attached to the shroud-mounting compartment cover, and extending into the brake compartment. Brake components are removed as in the second embodiment.

A better understanding of the disclosure herein will be obtained from the following detailed description and accompanying drawings.

### BRIEF DESCRIPTION OF THE DRAWINGS

FIG. 1 is a perspective view of an electric motor assembly including an electric brake assembly in accordance with the disclosure herein.

FIG. 2 is a perspective view of the electric motor assembly of FIG. 1, including an exploded view of certain components of the electric brake assembly.

FIG. 3 is an exploded perspective view of certain components of the electric motor assembly of FIG. 1, rotated 180 degrees in relation to FIG. 1.

FIG. 4 is a perspective view of the electric motor assembly of FIG. 1, including a fan and shroud assembly in place of the electric brake assembly of FIG. 1.

FIG. 5 is a perspective view of the electric motor assembly of FIG. 1, including an exploded view of the fan and shroud assembly of FIG. 4.

FIG. 6 is a perspective view of an alternate shroud-mounting compartment cover with additional fan guarding provisions for the electric motor assembly of FIG. 5.

FIG. 7 is an elevational view of an alternate fan guarding configuration for the electric motor assembly of FIG. 4.

FIG. 8 is a perspective view of the opposite side of the fan guarding configuration of FIG. 7.

FIG. 9 is a perspective view of the electric motor assembly with fan and shroud assembly of FIG. 4, rotated 180 degrees in relation to FIG. 4, and including a bracket-mounted motor controller.

FIG. 10 is a perspective view of the electric motor assembly of FIG. 9, rotated 180 degrees in relation to FIG. 9, with the fan, shroud and controller removed.

FIG. 11 is a perspective view of an electric motor assembly similar to that shown in FIG. 1, but without an electric brake assembly, and having a different motor end cap structure.

FIG. 12 is a perspective view of another embodiment of an electric motor assembly similar to that shown in FIG. 9, but including a motor controller mounted on brackets integrally formed on the motor end cap and motor mounting base.

FIG. 13 is a perspective view of the electric motor assembly of FIG. 12 with the fan, shroud and motor controller removed.

FIG. 14 is an elevation view of the motor mounting base of the electric motor assembly of FIG. 12.

FIG. 15 is a perspective view of an electric motor assembly similar to that shown in FIG. 4, but including an integrated motor controller.

FIG. 16 is a perspective view of the electric motor assembly of FIG. 15 with the fan and shroud and power plug removed.

FIG. 17 is a perspective view of the partial electric motor assembly of FIG. 16 with compartment covers removed to reveal electrical components.

FIG. 18 is a perspective view of the partial electric motor assembly of FIG. 17 including an exploded view of certain electrical components.

### DETAILED DESCRIPTION OF THE DRAWINGS

The description that follows describes, illustrates and exemplifies one or more embodiments in accordance with its principles. This description is not provided to limit the disclosure to the embodiment(s) described herein, but rather to explain and teach the principles of the invention(s) disclosed herein in order to enable one of ordinary skill in the art to understand these principles and, with that understanding, be able to apply them to practice not only the embodiment(s) described herein, but also any other embodiment that may come to mind in accordance with these principles. The scope of the disclosure is intended to cover all such embodiments that may fall within the scope of the appended claims, either literally or under the doctrine of equivalents.

It should be noted that the drawings set forth herein are not necessarily drawn to scale and, in some instances, proportions may have been exaggerated to more clearly depict certain features. As stated above, this specification is intended to be taken as a whole and interpreted in accordance with the principles of the invention(s) as taught herein and understood by one of ordinary skill in the art.

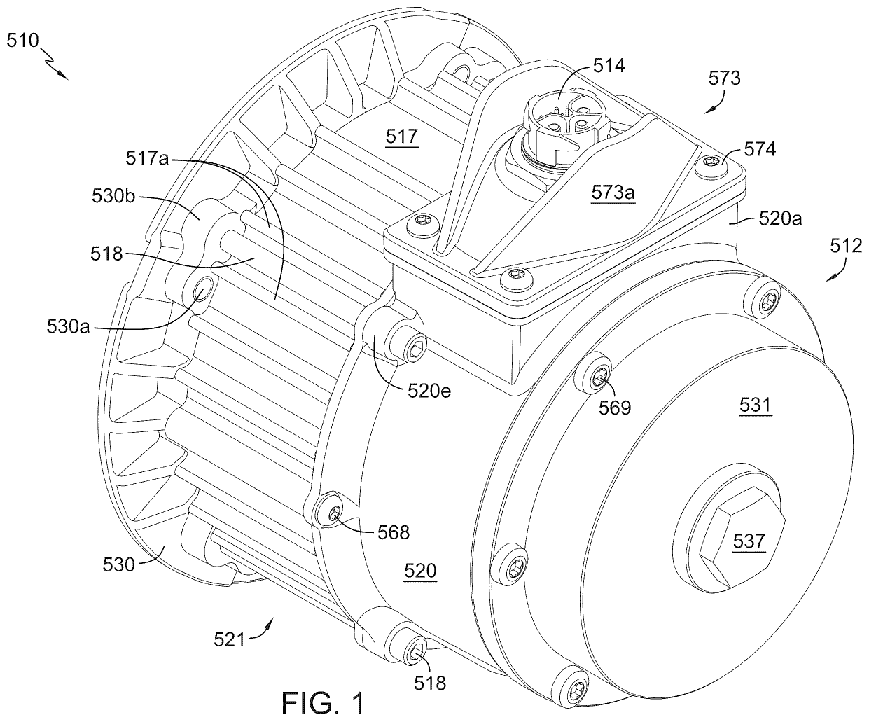

A first embodiment of an electric motor assembly 510 including an electric brake assembly 512 is shown in FIGS. 1-3. As illustrated, a motor mounting base 530 is joined to an electric motor end cap 520 via fasteners 518, with a motor stator housing 517 interposed between motor mounting base 530 and motor end cap 520 to form an electric motor compartment containing electric motor 521. Motor stator housing 517 may be preassembled to motor end cap 520 by means of fasteners 568.

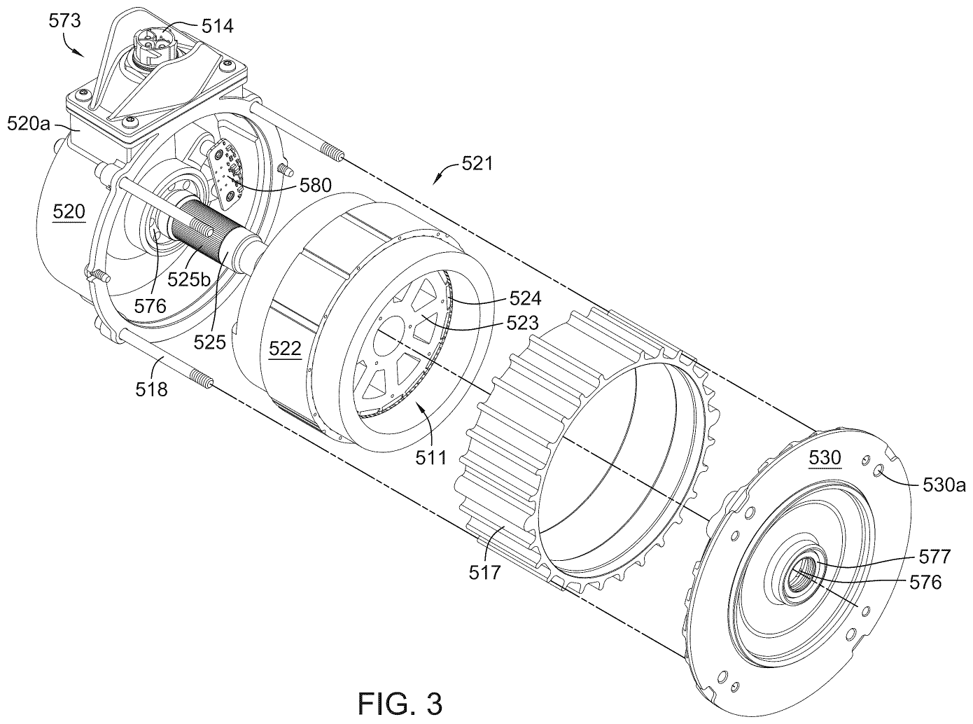

As best illustrated in FIG. 3, electric motor 521 comprises motor stator 522 and a motor rotor assembly 511 that includes motor rotor 523 and magnets 524. As shown, motor stator housing 517 may be a finned aluminum extrusion cut to a length dependent upon the number of laminations used to form the stator 522. The fins improve heat dissipation and provide stiffness but may not be required in some similar embodiments. For example, thickness of the cylindrical wall of the extrusion may be increased and/or material may be added at mounting lug locations, if needed. Fins may be omitted if structural requirements and motor performance requirements (such as running temperature) are met without fins. Also, other fin arrangements and profiles may be used. Referring to FIG. 1, each fastener 518 is flanked by fins 517a. This pair of fins 517a at each fastener 518 location may strengthen these joints by bearing against and structurally supporting one or both of the mounting lugs 520e and 530b formed on motor end cap 520 and motor mounting base 530, respectively. In each of the electric motor assembly embodiments disclosed herein, fastener flanking fins may serve as both heat dissipators and load bearing elements of the design.

An output shaft 525 extends through electric motor 521 and is supported by a pair of sealed bearings 576. A seal 577 is provided adjacent to one of the pair of bearings 576 as added environmental protection for this bearing. Splines 525b are provided on output shaft 525 for engaging rotor 523 of rotor assembly 511. A Hall effect board 580 is attached to motor end cap 520 adjacent to rotor assembly 511.

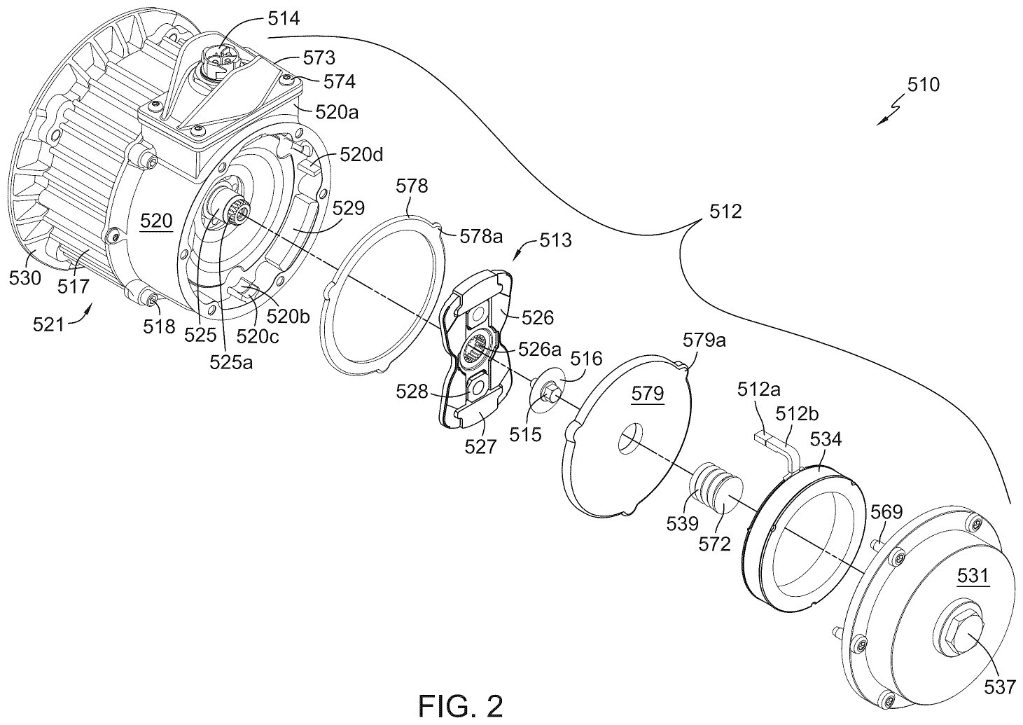

FIG. 2 shows the opposite side of motor end cap 520 where the electric brake assembly 512 is mounted. The electric brake assembly 512 includes and is partially housed within a brake coil housing 531 (also referred to as a “brake end cap” or “brake compartment cover”). Brake coil housing 531 is attached to the motor end cap 520 by means of fasteners 569 to form a brake compartment sealed by means of a gasket or sealant.

An electrical connector 514 is attached or mounted to an electrical compartment cover 573, which is secured by fasteners 574 to an electrical compartment 520a that extends from the motor end cap 520. The environmentally sealed electrical connector 514 may include motor power phase terminals, brake coil terminals and motor control terminals, and may be configured for connection to a vehicle or other mobile or non-mobile equipment control system. The electrical compartment cover 573 includes connector guards 573a that extend beyond the sealed electrical connector 514 to protect electrical connector 514.

Motor mounting base 530 includes mounting holes 530a to attach electric motor assembly 510 to a frame structure (such as a vehicle or equipment frame) or a driven component (such as a pump). Mounting holes 530a may be configured as bores or threaded bores, and may include threaded inserts.

Brake assembly 512 comprises a brake rotor assembly 513 disposed in the brake compartment. Brake rotor assembly 513 includes a pair of elastomeric puck isolators 528 and a pair of brake pucks 527 installed in brake rotor 526. As shown in FIG. 2, the brake rotor 526 has internal splines 526a that are slidingly engaged to external splines 525a of output shaft 525. A threaded fastener 515 and a washer 516 are then used to secure the brake rotor 526 to the electric motor output shaft 525.

An electric brake assembly such as that depicted herein, and including additional brake rotor configurations that may be utilized with the electric motor and brake embodiments disclosed herein, is illustrated and described in more detail in commonly-owned U.S. patent application Ser. No. 17/658,171, which is incorporated by reference herein in its entirety.

The brake rotor assembly 513 is positioned between a first stator 578 and a second stator 579 within the brake compartment. As shown in FIG. 2, a stator isolator or damper 529 may also be positioned in the housing compartment such that it bears against an inner surface of the housing compartment and against the outer edges of stators 578 and 579 to prevent or significantly reduce vibration and noise. Stator damper 529 may be a flat piece of rubber, for example, that is bent into a curved form at installation so that it simultaneously applies vibration damping pressure against an inner surface of motor end cap 520 and an outer edge or perimeter surface of one or both of the stators 578 and 579, as needed. Stators 578 and 579 are configured to provide a braking force to the brake rotor assembly 513 when under the influence of a biasing force imparted by compression spring 539. Stators 578 and 579 comprise a plurality of anti-rotation tabs 578a and a plurality of anti-rotation tabs 579a, respectively. The anti-rotation tabs 578a and anti-rotation tabs 579a engage mating grooves 520b and 520c, respectively, formed within motor end cap 520. The overall diameter (including anti-rotation tabs 578a) of the first stator 578 is less than the overall diameter (including anti-rotation tabs 579a) of the second stator 579, thereby preventing an incorrect assembly sequence of the two stators. Ribs 520d formed within motor end cap 520 further facilitate positioning of the stators 578, 579 within the motor housing compartment by ensuring that the anti-rotation tabs 578a, 579a are aligned with grooves 520b, 520c during assembly.

Electric brake coil 534 is positioned adjacent to the second stator 579 and is electrically joined to the electrical connector 514 via brake electrical conductors 512b and connector 512a. The electric brake coil 534 is disposed within a circular slot (not shown) formed in the brake coil housing 531. When electric brake coil 534 is energized via conductors 512b, electric brake coil 534 removes the braking force from stators 578 and 579 by electromagnetically pulling the second stator 579 away from the brake rotor assembly 513 and against the brake coil housing 531. That is, the electric brake coil 534, when energized, applies an electromagnetic force that is greater than the spring biasing force of spring 539 to second stator 579 to release second stator 579 from bearing against the brake rotor assembly 513, or more specifically, brake pucks 527. When electric brake coil 534 is de-energized, the biasing force of compression spring 539 presses the stator/rotor stack comprising second stator 579, rotor assembly 513 and first stator 578 against an inner surface of the motor end cap 520. The first stator 578 is preferably formed of high-carbon steel to limit the amount of wear caused by the brake rotor assembly 513 and/or to prevent the electromagnetic force of the electric brake coil 534 from moving the first stator 578. The second stator 579 is preferably formed of low-carbon steel and/or is thicker than first stator 578 to facilitate axial movement of second stator 579 by the electromagnetic force.

An appropriate steel alloy and thickness of second stator 579 is determined through engineering and testing to achieve a desired level of electromagnetic attraction to overcome the biasing spring force and hold second stator 579 in a disengaged position without significantly attracting first stator 578.

A spacer 572 may be positioned between compression spring 539 and external brake release plug 537 to prevent abrasion damage and contamination that could otherwise be caused by unwanted rotation of spring 539 against second stator 579. This abrasion may occur when installing or adjusting external brake release plug 537 to reduce or remove the biasing force to allow rotation of output shaft 525. Brake release plug 537 is preferably a threaded SAE plug comprising an O-ring for sealing a mating threaded plug aperture (not shown) formed in brake coil housing 531 when brake release plug 537 is installed in its brake biasing/operational position. Compression spring 539 is disposed in a cylindrical spring chamber (not shown) formed in brake coil housing 531 adjacent to the plug aperture. The spring chamber and plug aperture are axially collinear. The diameters of spacer 572 and compression spring 539 are larger than the diameter of the plug aperture, thus preventing the loss of spacer 572 or spring 539 through the aperture. When external brake release plug 537 is installed in the aperture and tightened, it bears against spacer 572 which bears against spring 539 which bears against and applies a biasing force to the second stator 579 to press the stator/rotor stack (comprising second stator 579, rotor assembly 513 and first stator 578) against an internal surface of motor end cap 520. The brake release plug 537 can be loosened to adjust (reduce or eliminate) the biasing force to allow relatively free movement of output shaft 525 as may be desired when, for example, electrical power is unavailable to disengage the brake.

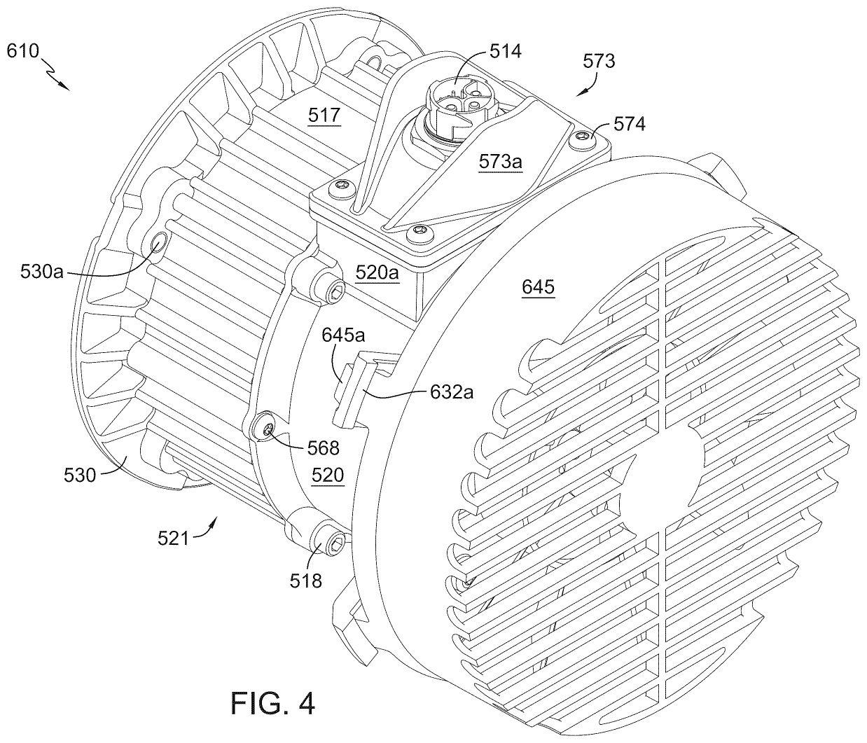

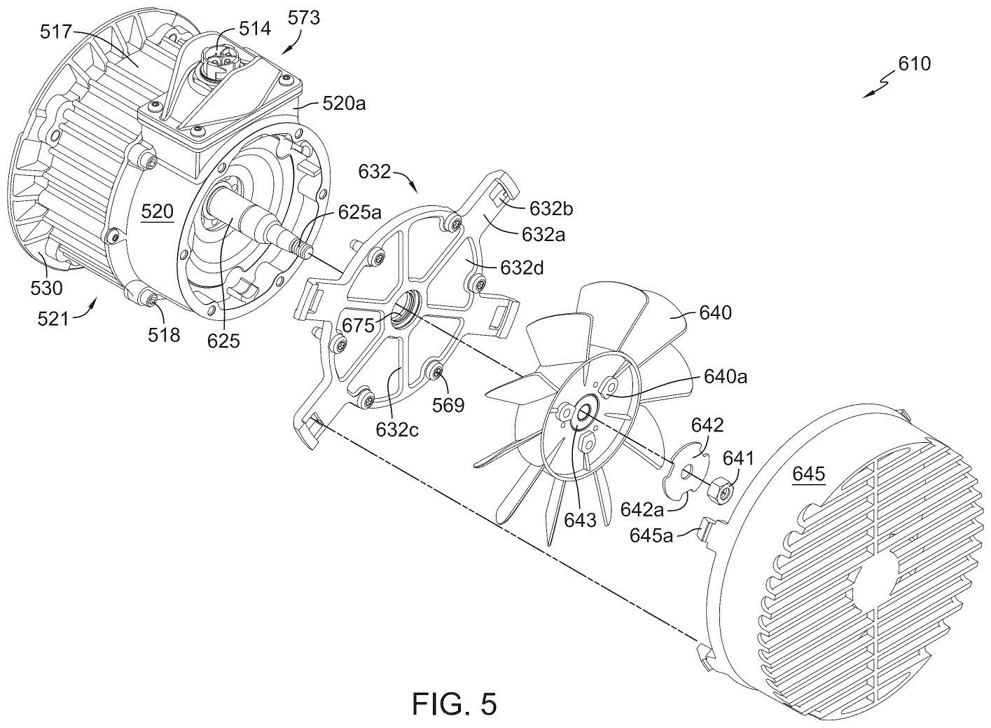

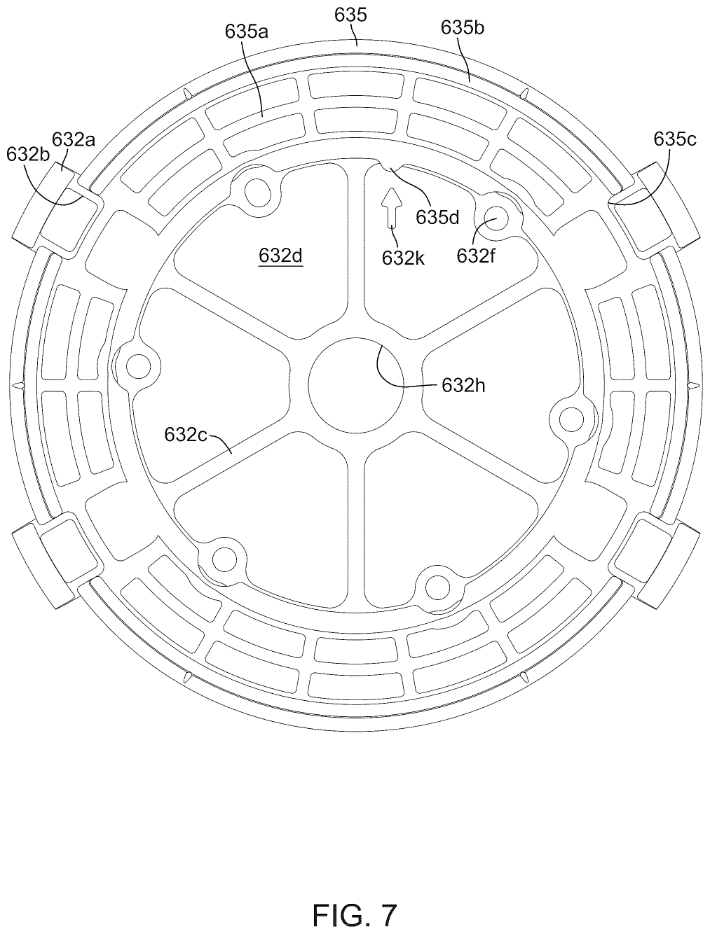

A second embodiment of an electric motor assembly 610 is shown in FIGS. 4 and 5. In this embodiment, the brake components of the first embodiment have been removed and the brake compartment cover 531 is replaced by an interchangeable shroud-mounting compartment cover 632 including a central hole 632h (see FIG. 7) with a shaft seal 675 retained therein. Shroud-mounting compartment cover 632 includes a plurality of shroud mounting arms 632a, each having a slot 632b formed therein for engaging locking tabs 645a of fan shroud 645. In this embodiment, a fan 640 is mounted on an output shaft 625 that extends through electric motor 521. As with other the other motor output shafts described herein, output shaft 625 has a first end that extends out of the motor mounting base 530 and a second end that extends out of an open end of the motor end cap 520. Fan 640 is secured to shaft 625 by means of a slotted washer 642 and locknut 641 and helps cool electric motor assembly 610 during operation. The slots 642a of slotted washer 642 engage corresponding protrusions 640a formed about hub 643 on fan 640 and locknut 641 engages threaded end 625a of output shaft 625. The shroud-mounting compartment cover 632 material is preferably aluminum, as are the other housing components of electric motor assembly 610, due to its advantageous convection and heat dissipation properties. However, various other metals, plastics or composites could be used depending on cost, weight, and other constraints or considerations. Shroud-mounting compartment cover 632 has a central disc portion 632d formed of thinner material (e.g., aluminum) and thicker radial ribs 632c that strengthen and stiffen compartment cover 632 while further enhancing heat dissipation. When installed using fasteners 569, compartment cover 632 fits to the motor end cap to seal inner components of electric motor 521.

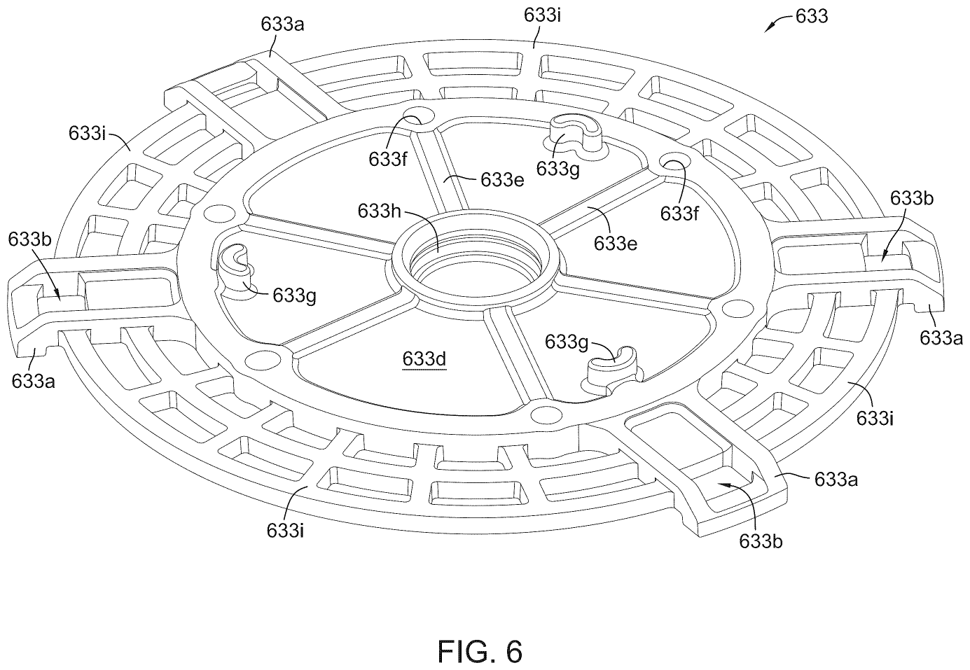

FIG. 6 depicts an alternate shroud-mounting compartment cover 633 that may be used in lieu of compartment cover 632 for alternative guarding of fan 640. In this figure, compartment cover 633 is viewed from the side adjacent to motor end cap 520. Similar to compartment cover 632, compartment cover 633 includes a plurality of shroud mounting arms 633a with slots 633b, and a solid central disc portion 633d with a first set of radial ribs (not shown in FIG. 6 but may be the same as radial ribs 632c shown in FIG. 5) and a second set of radial ribs 633e with holes 633f for fasteners 569 located at the outer ends of radial ribs 633e. Both of the covers 632 and 633 may also include assembly aids such as alignment protrusions 633g to engage grooves 520c of motor end cap 520. Another commonality is a central hole 633h for output shaft 625 and for seating of shaft seal 675. For additional guarding and strengthening, concentric webbing structure 633i is provided around the periphery of central disc portion 633d between each of the shroud mounting arms 633a of compartment cover 633.

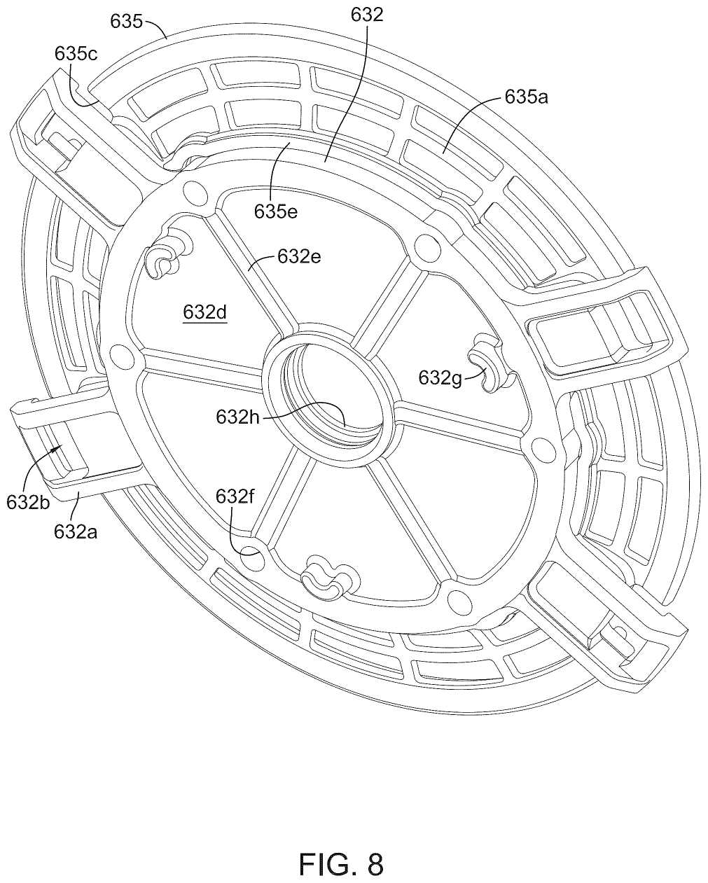

FIGS. 7 and 8 depict another option for guarding fan 640 comprising compartment cover 632 and a fan guard ring 635 with concentric webbing structure 635a, forming vents for the passage of airflow. During assembly, compartment cover 632 is installed using fasteners 569 and mounting holes 632f formed in compartment cover 632. Then, fan guard ring 635 is positioned adjacent to compartment cover 632 prior to installing the fan 640. Finally, installation of the fan shroud 645 securely retains the fan guard ring 635 against compartment cover 632 when locking tabs 645a (see FIG. 5) engage slots 632b formed in shroud mounting arms 632a. A clearance cutout 635c is located to align with each slot 632b and a perimeter rib 635b may be provided between each clearance cutout 635c for added strength.

Fan guard 635 may also include alignment and retention features such as visual alignment indicator 635d shown in FIG. 7 and overlapping rim 635e shown in FIG. 8. Overlapping rim 635e concentrically overlaps the perimeter of central disc portion 632d to securely position the fan guard ring 635 on compartment cover 632 while further strengthening fan guard ring 635. A positioning arrow 632k may be formed on the surface of central disc portion 632d to be used as an assembly aid in conjunction with visual alignment indicator 635d. Such visual indicators may be used by assembly personnel and for machine vision assembly verification.

In FIG. 8, compartment cover 632 and fan guard ring 635 are viewed from the side adjacent to motor end cap 520, so features common with compartment cover 633 can be seen. Compartment cover 632 includes solid disc portion 632 (d) containing a second set of radial ribs 632e with holes 632f for fasteners 569 located at the outer ends of radial ribs 632e. Alignment protrusions 632g that engage grooves 520c (shown in FIG. 2) of motor end cap 520 can also be seen. Radial ribs 632c, 632e are formed on opposite sides of compartment cover 632 and may be radially offset from one another as illustrated. Ribs 632c, 632e may or may not be equally spaced.

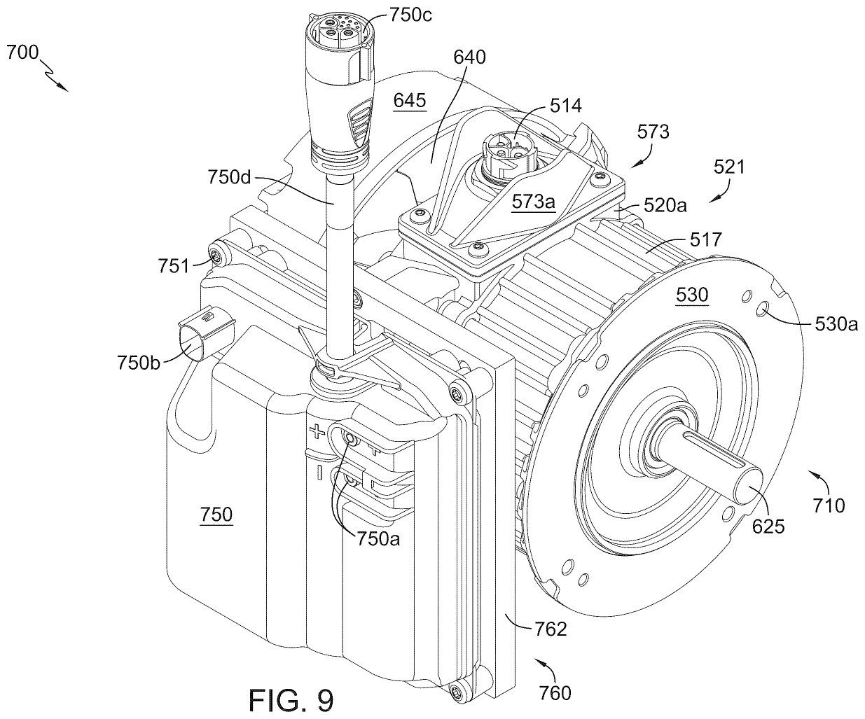

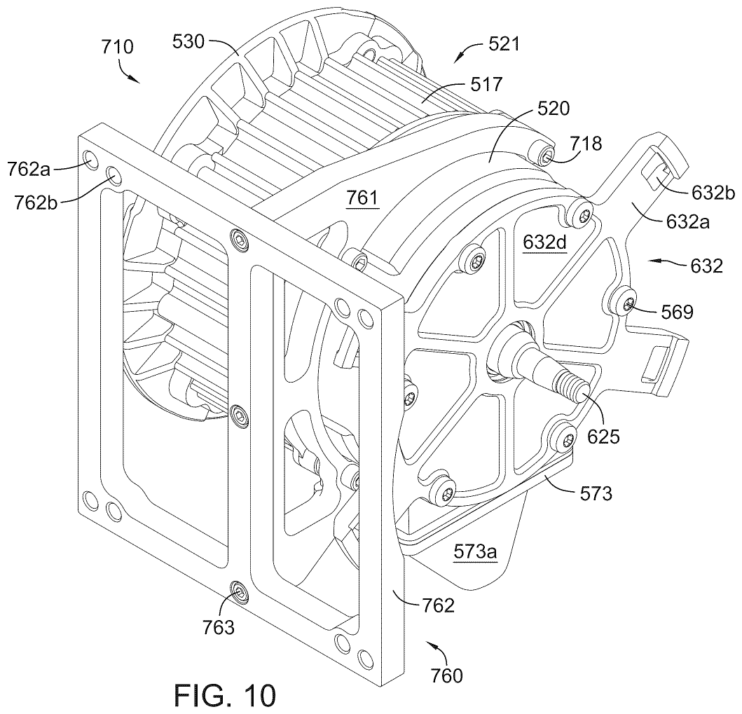

In a third embodiment, an electric motor and controller assembly 700 is shown in FIGS. 9 and 10. In this embodiment, an electric motor controller 750 is bracket-mounted on an electric motor assembly 710 that is the same as or substantially similar to electric motor assembly 610. A fan 640 is driven by motor shaft 625 and protected by fan shroud 645, such as described in the previous embodiment. But here, the fan is positioned to not only direct cooling airflow at electric motor 521, it also helps cool motor controller 750. In FIG. 9, a representative electric motor controller 750 is depicted. It will be understood that other controllers compatible with electric motor assembly 710 or modified versions of motor assembly 710 (e.g. having different electrical connectors, electrical capacities, etc.) may be used in this embodiment.

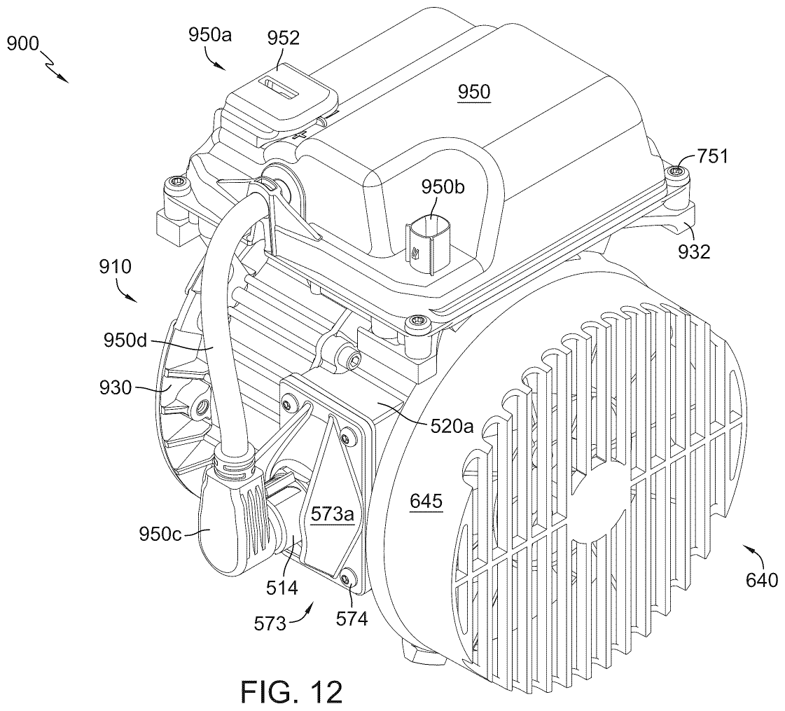

Electric motor controller 750 includes a pair of DC power terminals 750a and a CAN bus connector 750b for power and communication inputs, respectively. Power and communication outputs are provided via three-phase power & CAN bus connector 750c attached to the end of a flexible electrical cable 750d extending from controller 750. Connector 750c may be attached to connector 514 of electric motor assembly 710 to form an environmentally sealed electrical connection during operation of electric motor and controller assembly 700. Connector 750c is illustrated in this embodiment as a straight connector, but may also be configured as a right-angle connector, such as that shown in FIG. 12, or as any other suitable configuration of connector. The base of electric motor controller 750 on which it is mounted comprises a heat sink portion to draw heat out of the controller.

As illustrated in FIG. 10, electric motor controller 750 has been removed to reveal the T-bracket 760 on which it is mounted. The T-bracket is assembled, joined or formed in a generally T-shaped configuration and includes a first set of controller mounting holes 762a and a second set of controller mounting holes 762b. T-bracket 760 (also referred to as a “controller mounting bracket”) may optionally include one set or more than two sets of controller mounting holes, depending on suitable controller options, compatible motors, inventory considerations, etc. T-bracket 760 is attached to electric motor assembly 710 using fasteners 718 (fastener lengths may be varied, as needed) that also serve to join motor mounting base 530 to electric motor end cap 520. T-bracket 760 comprises a wrap-around bracket 761 (also referred to as a “mounting arm”) and a controller mounting platform 762 that are joined by a plurality of fasteners 763. Optionally, wrap-around bracket 761 and controller mounting platform 762 may be welded (not shown) rather than joined by fasteners 763. In the illustrated configuration, bracket 761 fits against an exterior surface of motor end cap 520 of electric motor 521 and extends approximately 180 degrees around the circumference thereof and employs three fasteners 718 to ensure secure mounting of T-bracket 760 and controller 750 to the motor end cap 520 of motor assembly 710.

Alternatively, T-bracket 760 may be formed as a single component (for example, an aluminum casting or a 3D printing) comprising a wrap-around bracket portion 761 and a controller mounting platform portion 762 oriented perpendicular to the wrap-around bracket portion 761. As shown in FIG. 9, the heat sink portion of controller 750 is attached to T-bracket 760 by means of fasteners 751. Though fan 640 and shroud 645 have been removed in FIG. 10, their location over motor shaft 625 in relation to the T-bracket 760 allow for improved cooling of the controller 750.

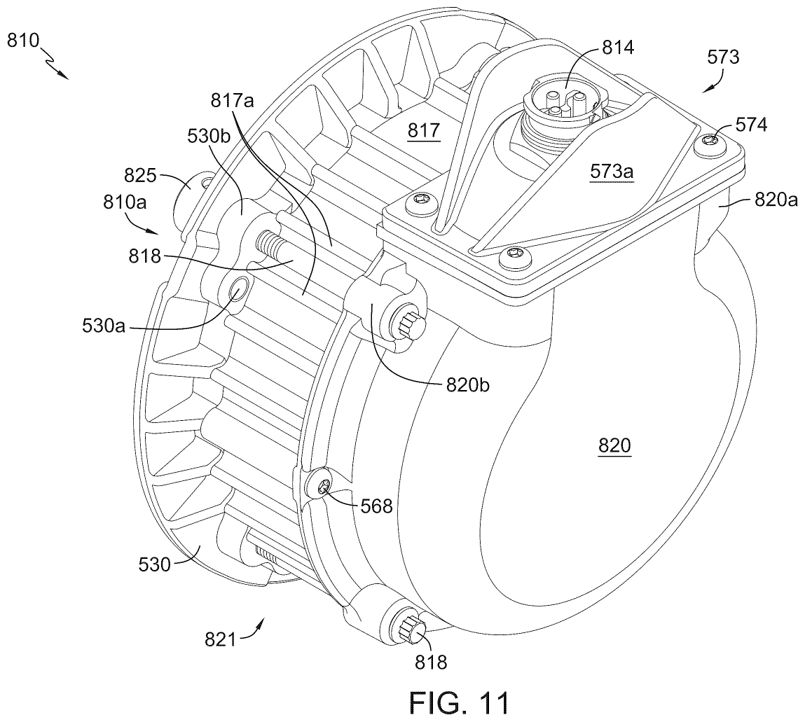

A fourth embodiment of an electric motor assembly 810 is illustrated in FIG. 11. Electric motor assembly 810 does not include a brake, fan or bracket-mounted controller and may therefore be a lower cost option suitable for some applications. This motor may be configured with or without a Hall effect board, such as Hall effect board 580 shown in FIG. 3. Without a Hall effect board, electric motor assembly 810 can include a less expensive electrical connector 814 having power terminals only, as shown. Also, as shown in FIG. 11, motor output shaft 825 does not extend through motor end cap 820, resulting in a reduced cost of sealing the motor output shaft compared to other embodiments illustrated herein. Motor mounting base 530 is joined to electric motor end cap 820 via fasteners 818, with a motor stator housing 817 interposed between motor mounting base 530 and motor end cap 820 to form an electric motor compartment containing an electric motor 821 that may be substantially equivalent to electric motor 521 shown in FIG. 3. Similar to motor stator housing 517, motor stator housing 817 may be a finned aluminum extrusion cut to a length dependent upon the number of laminations used to form the stator. Each fastener 818 is flanked by fins 817a. A pair of flanking fins 817a bears against mounting lugs 820b and 530b to provide structural support and stiffness at each of a plurality of structural joints 810a of electric motor assembly 810. Electrical connector 814 is attached to electrical compartment cover 573, which is secured by fasteners 574 to an electrical compartment 820a that is integrally formed on the motor end cap 820.

In a fifth embodiment, an electric motor and controller assembly 900 is illustrated in FIGS. 12-14. In this embodiment, the controller mounting bracket is comprised of separate first and second brackets for mounting a motor controller 950 that are integrally formed on motor mounting base 930 and shroud-mounting compartment cover 932 of a sealed electric motor assembly 910. Similar to the third embodiment, a fan 640 helps cool both the electric motor assembly 910 and the motor controller 950. Like motor controller 750, motor controller 950 comprises a heat sink portion on the surface that mounts to the brackets. Again, the brackets are preferably constructed of aluminum or other heat dissipating material. The bracket integrally formed with compartment cover 932 provides heat dissipation from the controller 950 directly into the path of airflow from the fan 640. In FIG. 12, a representative electric motor controller 950 is depicted. It will be understood that other controllers compatible with electric motor assembly 910 or modified versions of motor assembly 910 (e.g. having different electrical connectors, electrical capacities, etc.) may be used in this embodiment.

The depicted electric motor controller 950 includes a pair of DC power terminals 950a (protected by a terminals cover 952 that can also be used with controller 750) and a CAN bus connector 950b for power and communication inputs, respectively. Power and communication outputs are provided via three-phase power & CAN bus right-angle connector 950c attached to the end of electrical cable 950d extending from controller 950. Connector 950c may be attached to connector 514 of electric motor assembly 910 to form an environmentally sealed electrical connection during operation of electric motor and controller assembly 900. Electrical connector 514 is, in turn, attached to electrical compartment cover 573, which is secured by fasteners 574 to an electrical compartment 520a that is integrally formed on the motor end cap 520. As shown in FIG. 12, when assembled, electrical compartment 520a extends from a side of the motor assembly no more than 90 degrees around the circumference of the motor assembly from where electric motor controller 950 mounts. This compact design allows for a short electrical cable 950d.

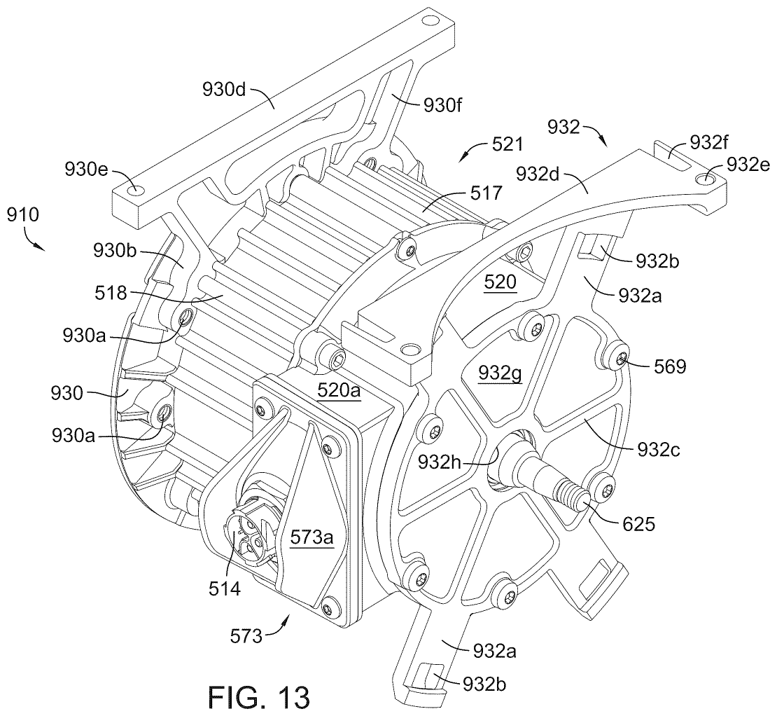

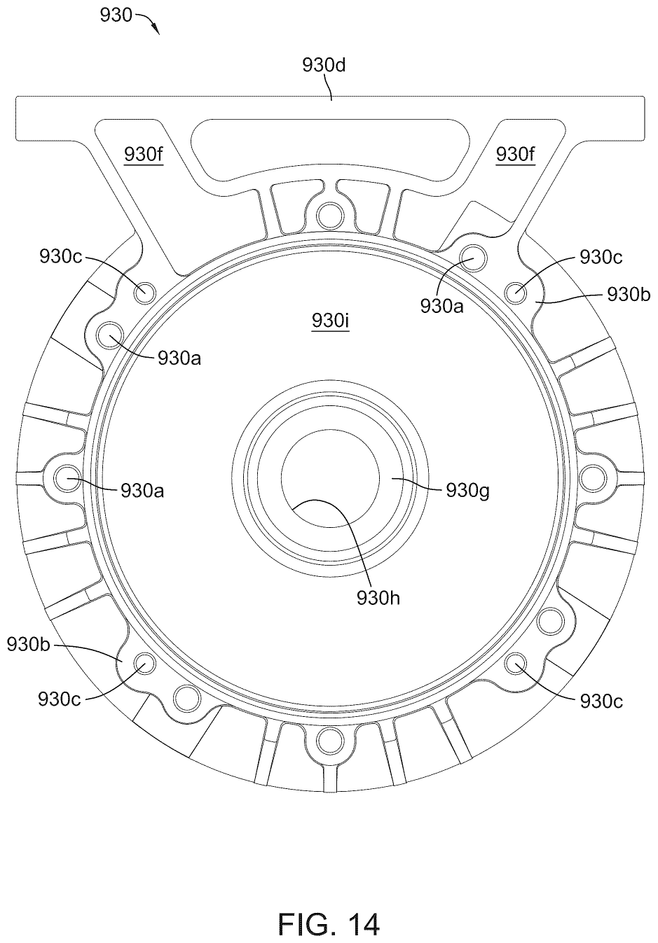

Shroud-mounting compartment cover 932 is shown most clearly in FIG. 13 while motor mounting base 930 is shown in FIGS. 13 and 14. These two components provide the first and second brackets that cooperatively present a flat surface for mounting of motor controller 950 via fasteners 751 on electric motor assembly 910, thereby forming electric motor and controller assembly 900. Compartment cover 932 is similar to compartment cover 632 shown in FIG. 5, including a solid central disc portion 932g that covers over the top of motor end cap 520, radial ribs 932c, and a plurality of shroud mounting arms 932a extending radially therefrom, each having a slot 932b formed therein for engaging locking tabs 645a of fan shroud 645, and also including a central hole 932h for motor output shaft 625. In addition to these commonalities with compartment cover 632, compartment cover 932 also includes a bridge 932d that spans two of the shroud mounting arms 932a to form the first bracket of the controller mounting bracket. Bridge 932d may include a set of controller mounting holes 932e and a set of controller mounting slots 932f to accommodate mounting of more than one type of controller. It will be understood that various controllers compatible with electric motor assembly 910 or modified versions of motor assembly 910 (e.g. having different electrical connectors, electrical capacities, etc.) may be used in this embodiment.

Similar to motor mounting base 530, motor mounting base 930 includes a plurality of mounting holes 930a formed in mounting lugs 930b to attach electric motor assembly 910 to a frame structure (such as a vehicle or equipment frame) or a driven component (such as a pump). Mounting holes 930a may be configured as bores or threaded bores, and may include threaded inserts. A plurality of threaded bores 930c for attachment of motor end cap 520 via fasteners 518 is indicated in FIG. 14. Similar to compartment cover 932, motor mounting base 930 also includes a bridge 930d that spans two integrally-formed arms 930f that extend radially from a central disc portion 930i to form the second bracket for mounting the controller. Bridge 930d may include a set of controller mounting slots and/or holes 930e (holes shown in FIG. 13). A central hole 930h for motor output shaft 625 is formed in the center of central disc portion 930i and a bearing pocket 930g is formed concentrically about central hole 930h.

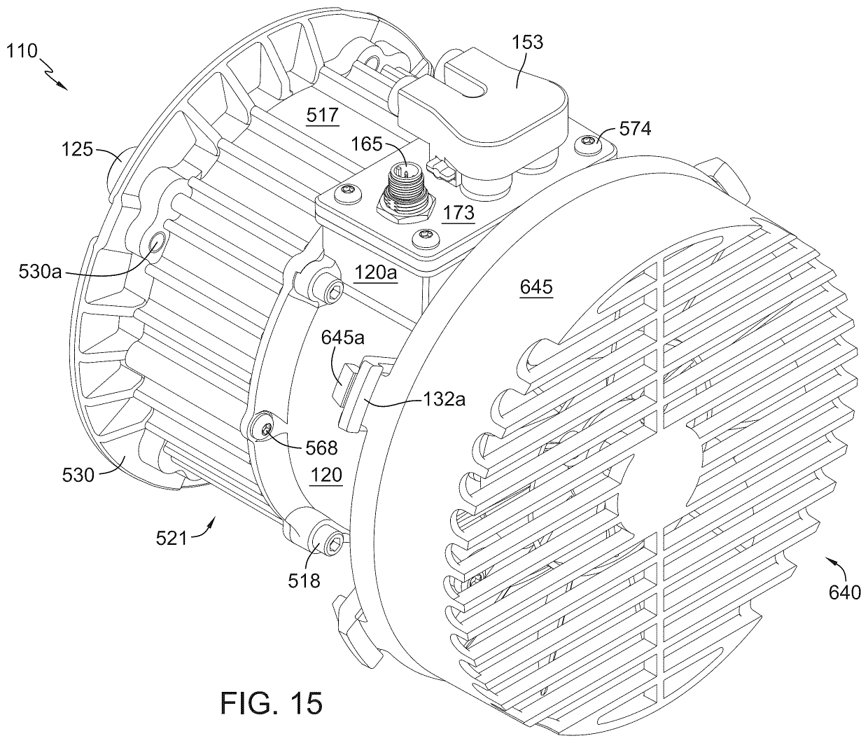

A sixth embodiment of the electric motor is illustrated in FIGS. 15-18. Electric motor assembly 110 includes a shroud-mounting compartment cover and a fan shroud similar to that of the second embodiment. An integrated electric motor controller 150 comprising stacked circuit boards is positioned beneath the shroud-mounting compartment cover 132. Shroud-mounting compartment cover 132 includes a plurality of shroud mounting arms 132a, each having a slot 132b formed therein for engaging locking tabs 645a of fan shroud 645. A fan 640 is mounted on an output shaft 125 that extends through electric motor 521. Shroud-mounting compartment cover 132 has a central disc portion 132d including threaded protrusions 132c that accommodate attachment of circuit boards of the integrated electric motor controller 150. Shroud-mounting compartment cover is preferably made of aluminum or other heat-dissipating material to absorb heat from the integrated electric motor controller 150 on one side and dissipate it with airflow from fan 640 on the other side.

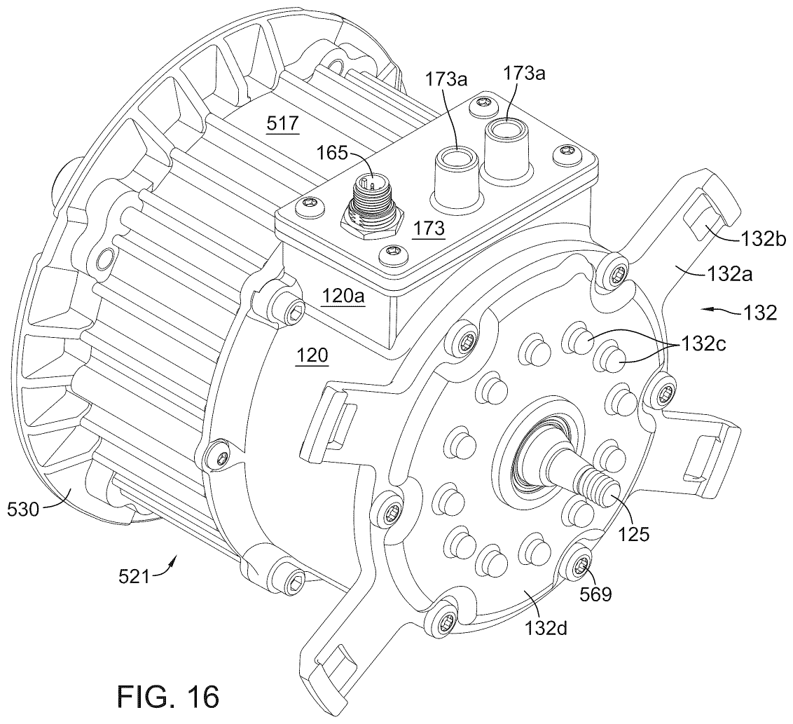

As shown in FIG. 16, two DC power risers 173a extend from electrical compartment cover 173. An electrical plug, such as right-angle locking DC power plug 153 shown in FIG. 15, engages the DC power risers. CAN bus connector 165 is attached to compartment cover 173 for communication with electric motor 521. Compartment cover 173 is secured by fasteners 574 to electrical compartment 120a that extends from motor end cap 120.

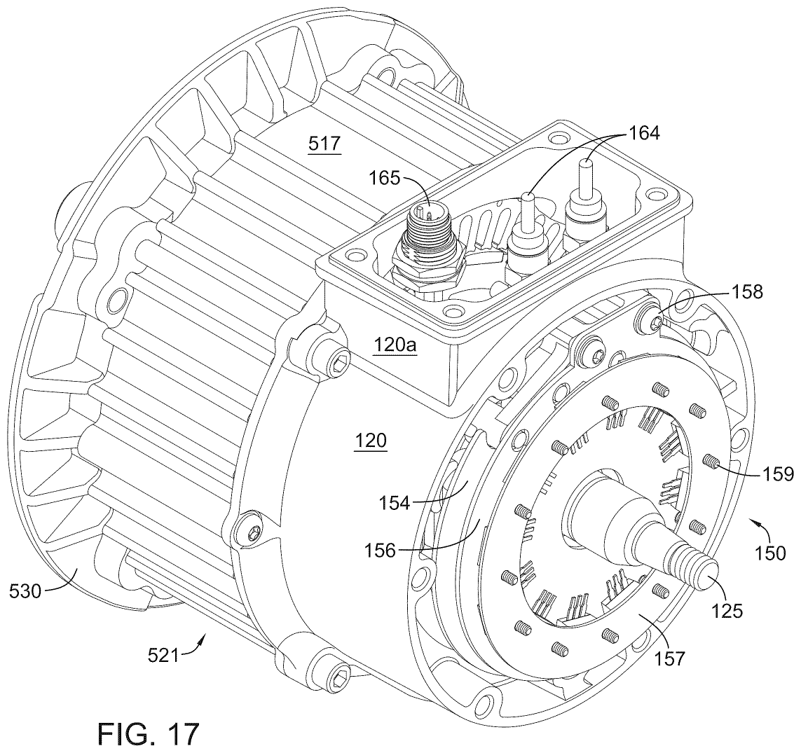

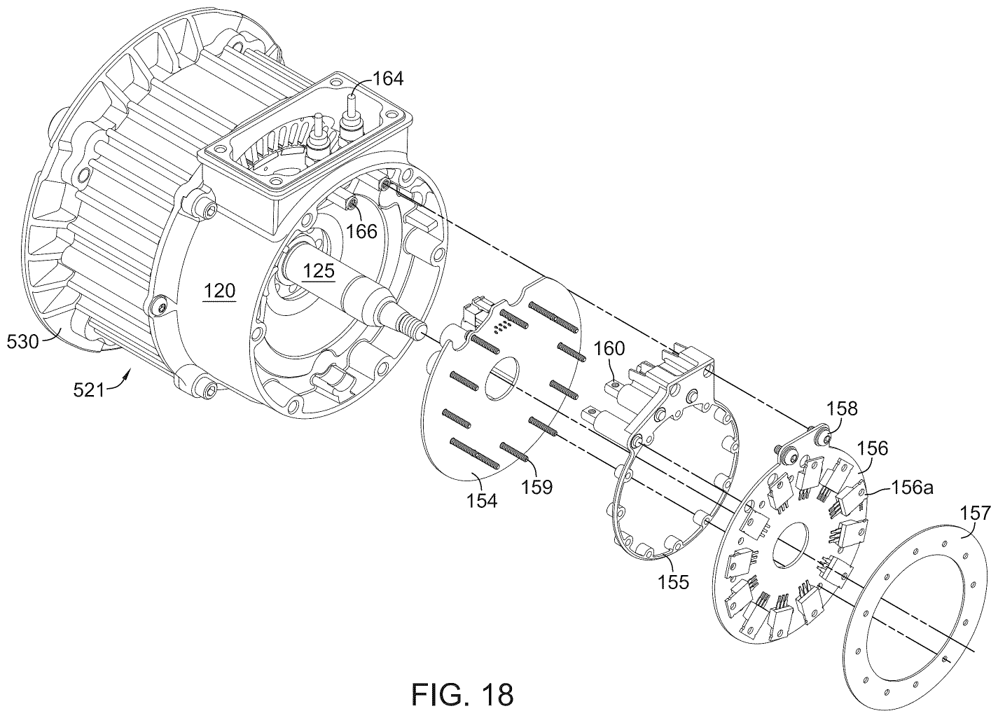

In FIGS. 17 and 18, compartment covers 173 and 132 are removed to reveal components of integrated electric motor controller 150. DC terminal posts 164 extend into the two DC power risers 173a for connection to the DC power plug 153. DC terminal posts 164 are connected to DC power lugs 166 which are seated on power connection board spacer 155 (when assembled) and secured by fasteners 158 that extend through electronic power board 156. Three-phase power posts 160 are also seated on power connection board spacer 155. Terminal ends of motor windings (not shown) are connected to the three-phase power posts 160 during assembly.

A plurality of fasteners 159 extend through and secure logic control board 154, board spacer 155, electronic power board 156, and thermal pad 157 by engaging the threaded protrusions 132c of compartment cover 132. Thermal pad 157 is positioned between electronic power board 156 and compartment cover 132 to help dissipate heat generated by a plurality of field effect transistors (FETs) 156a mounted on electronic power board 156. Compartment cover 132 receives airflow directly from the adjacent fan 640 for effective cooling of FETs 156a and electronic power board 156.

While the foregoing embodiments have many potential practical applications, applicants note that the benefits of fan cooling on a motor, or a motor-controller combination are best realized when the fan turns consistently and at a high rate of speed. Thus, preferred applications of embodiments including a fan are for use with implements requiring relatively high and constant RPMs when in operation in order to generate useful airflow. Various examples of electric motor assemblies and motor and controller assemblies contemplated herein are set forth below.
Example 1. An electric motor assembly includes a motor end cap, a mounting base joined to the motor end cap, and a motor output shaft. The motor output shaft has a first end extending through the mounting base and a second end extending through the motor end cap. The electric motor assembly also includes a fan mounted on the second end of the motor output shaft. It also includes a compartment cover with a central hole through it, and the second end of the motor shaft passes through the central hole. The compartment cover is configured to attach to and cover an open end of the motor end cap. The electric motor assembly also includes a fan shroud covering over the fan. The fan shroud is removably attached to the compartment cover.
Example 2. The electric motor assembly of Example 1, wherein the compartment cover comprises a plurality of arms extending away from the central hole and beyond an outer circumference of the motor end cap.
Example 3. The electric motor assembly of Example 2, wherein the plurality of arms each have a slot that mates to a locking tab of the fan shroud to hold the fan shroud in place.
Example 4. The electric motor assembly of Example 3, further comprising a fan guard ring is supported by the plurality of arms. The fan guard ring extends around the outer circumference of the motor end cap to prevent operator fingers or larger debris from reaching the fan
Example 5. The electric motor assembly of Example 4, wherein the fan guard ring is vented, allowing for airflow from the fan to move along the outer circumference of the motor end cap to help cool the electric motor assembly.
Example 6. The electric motor assembly of any Examples 1-5, wherein the fan and fan shroud are interchangeable with an electric brake assembly.
Example 7. The electric motor assembly of any Examples 1-5, further comprising a stator housing positioned between the mounting base and the motor end cap. The stator housing has an external surface featuring a plurality of fins extending away from the motor output shaft.
Example 8. The electric motor assembly of Example 8 further comprising a plurality of fasteners connect the motor end cap to the mounting base, and, in some cases, each of the plurality of fasteners is flanked on either side by one of the plurality of fins.
Example 9. An electric motor and controller assembly that comprises an electric motor assembly including a mounting base joined to a motor end cap. The motor end cap comprises a compartment with an opening facing away from the mounting base. A compartment cover is attached to the motor end cap to seal the compartment. A motor output shaft has a first end that extends through the mounting base and a second end that extends through the compartment cover. A fan is mounted on the second end of the motor output shaft, and a fan shroud is attached to the compartment cover. A controller mounting bracket is mounted on the motor assembly, and a motor controller is mounted on the controller mounting bracket. The fan cools both the electric motor assembly and the motor controller during operation of the electric motor and controller assembly.
Example 10. The electric motor and controller assembly of Example 9 wherein a brake compartment cover of an electric brake assembly is interchangeable with the compartment cover.
Example 11. An electric motor and controller assembly comprising an electric motor positioned between a motor mounting base and a motor end cap. The motor end cap has a cylindrical outer surface. The electric motor and controller assembly further comprises an electrical compartment presenting an electrical connector facing away from the motor end cap. It also comprises a controller mounting bracket with both a mounting platform and a mounting arm. The mounting platform provides a flat surface for mounting a controller, and the mounting arm extends perpendicularly away from the flat surface to connect with the motor end cap. The electric motor and controller assembly also includes a motor controller mounted to the flat surface of the mounting platform. There is an electrical cable extending from the motor controller and having a mating end for connection to the electrical connector.
Example 12. The electric motor and controller assembly of Example 11, wherein the mounting arm has a curved mounting surface configured to align with and wrap around at least a portion of the cylindrical outer surface of the motor end cap.
Example 13. The electric motor and controller assembly of Examples 11 or 12, wherein the electrical cable has a total length that is less than a length around the cylindrical outer surface of the motor end cap.
Example 14. The electric motor and controller assembly of any of Examples 11-13, further comprising a motor output shaft extending through the electric motor and having a first end and a second end, a fan connected to and rotatable with the first end of the motor output shaft, and a fan shroud covers over the fan.
Example 15. The electric motor and controller assembly of Example 14, further comprising a compartment cover that fits over an open end of the motor end cap. The compartment cover presents a plurality of arms that extend beyond the cylindrical outer surface of the motor end cap to receive locking tabs of the fan shroud to hold the fan shroud in place over the fan.
Example 16. An electric motor assembly comprising a motor end cap with a mounting base joined to it. The assembly includes a motor output shaft having a first end extending through the mounting base and a second end terminating beneath the motor end cap. It also includes a stator housing positioned between the mounting base and the motor end cap. The stator housing comprises an external surface featuring a plurality of fins extending away from the motor output shaft. A plurality of fasteners connect the motor end cap to the mounting base, and each of the plurality of fasteners is flanked on each side by one of the plurality of fins.
Example 17. The electric motor assembly of Example 16, further comprising an electrical compartment that presents an electrical connector facing perpendicularly away from a central axis of the motor output shaft.
Example 18. The electric motor assembly of Example 17, wherein the electrical connector is configured to receive power and control signals for operating an electric motor within the electric motor assembly.
Example 19. The electric motor assembly of Examples 17 or 18, wherein the electrical connector is protected by connector guards extending from the electrical compartment.
Example 20. The electric motor assembly of any of Examples 17-19, wherein the power and control signals are received from a controller mounted to a side of the electric motor assembly.
Example 21. The electric motor assembly of Example 20, further comprising one or more brackets mounted to the mounting base and/or the motor end cap to support the controller.
Example 22. The electric motor assembly of Example 21, further comprising an electrical connector for receiving the power and control signals extends from the controller to the electrical compartment. The electrical connector extends no more than ninety degrees around an outer circumference of the electric motor assembly.
Example 23. An integrated electric motor and controller. The electric motor comprises a rotor having a first central hole, a stator having a second central hole, and a motor output shaft extending through the first central hole and the second central hole. The controller is configured to provide electronic inputs to the electric motor. The controller has a logic control board with a third central hole through which the motor output shaft also extends.
Example 24. The integrated electric motor and controller of Example 23, wherein the controller further comprises a plurality of transistors positioned radially around the motor output shaft.
Example 25. The integrated electric motor and controller of Example 24, wherein the plurality of transistors are positioned on an electronic power board having a fourth central hole. The motor output shaft also extends through this fourth central hole.
Example 26. The integrated electric motor and controller of Example 24, wherein the electronic power board is secured to the logic control board with a plurality of fasteners positioned radially around the motor output shaft.
Example 27. The integrated electric motor and controller of any of Examples 24-26, wherein the controller further comprises a thermal pad radially positioned around the motor output shaft and adjacent the plurality of transistors.
Example 28. The integrated electric motor and controller of any of Examples 23-27, further comprising a housing containing each of the rotor, the stator and the logic control board.
Example 29. The integrated electric motor and controller of Example 28, wherein the housing comprises a motor mounting base, a motor end cap, and a shroud-mounting compartment cover.
Example 30. The integrated electric motor and controller of Example 29, wherein the motor output shaft has a first end extending through the motor mounting base and a second end extending through the shroud-mounting compartment cover.
Example 31. The integrated electric motor and controller of any of Examples 28-30, further comprising a plurality of three-phase power posts positioned within the housing and connected to the logic control board.
Example 32. The integrated electric motor and controller of Example 31, further comprising positive and negative DC power terminals extending from the housing.
Example 33. The integrated electric motor and controller of Example 23, further comprising an electronic power board on which a plurality of transistors is disposed.
Example 34. The integrated electric motor and controller of Example 33, wherein the electronic power board has a fourth central hole, and the motor output shaft further extends through the fourth central hole.
Example 35. The integrated electric motor and controller of Examples 33 or 34, wherein the electronic power board is attached to positive and negative DC power terminals.
Example 36. An integrated electric motor and controller comprising a mounting base and a motor end cap joined to the motor mounting base. The motor end cap has an open end facing away from the mounting base. The integrated electric motor and controller also comprises a motor output shaft with a first end extending through the mounting base and a second end extending through the open end of the motor end cap. The integrated electric motor and controller also comprises an electric motor controller radially positioned around the motor output shaft near the open end of the motor end cap.
Example 37. The electric motor and controller assembly of Example 36, further comprising a compartment cover having a central hole through which the second end of the motor shaft passes. The compartment cover is configured to attach to and cover an open end of the motor end cap, thereby enclosing the electric motor controller inside the motor end cap.
Example 38. The electric motor and controller assembly of Example 37, further comprising a fan mounted on the second end of the motor output shaft and oriented to direct airflow at the compartment cover.
Example 39. The electric motor and controller assembly of Examples 37 or 38, wherein the electric motor controller comprises a thermal pad seated against an inner surface of the compartment cover for transferring heat from the electric controller to the compartment cover.
Example 40. The electric motor and controller assembly of Example 38, further comprising a fan shroud covering the fan. The fan shroud is removably attached to the compartment cover.
Example 41. The electric motor and controller assembly of any of Examples 36-40, further comprising an electrical compartment extending from a side of the motor end cap. The electrical compartment comprises positive and negative DC power risers.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalent thereof.

What is claimed is:

1. An electric motor and controller assembly, comprising:
an electric motor assembly including a mounting base joined to a motor end cap;
a motor output shaft having a first end extending through the mounting base and a second end extending through the motor end cap;
a fan mounted on the second end of the motor output shaft;
a controller mounting bracket attached to the electric motor assembly; and
a motor controller mounted on the controller mounting bracket and electrically connected to the electric motor assembly by means of an electrical connector;
wherein the fan is oriented to direct an airflow across both the motor end cap and at least a portion of the motor controller during operation of the electric motor and controller assembly.

2. The electric motor and controller assembly of claim 1, further comprising a first set of fasteners, each of which fastens the mounting base to the motor end cap and also fastens the controller mounting bracket to the electric motor assembly.

3. The electric motor and controller assembly of claim 1, wherein the controller mounting bracket comprises a mounting arm and a controller mounting platform oriented perpendicular to the mounting arm.

4. The electric motor and controller assembly of claim 3, wherein the mounting arm fits against an exterior circumference of the electric motor assembly and extends greater than ninety degrees around the exterior circumference.

5. The electric motor and controller assembly of claim 3, further comprising a plurality of fasteners for connecting the mounting arm to the motor end cap, wherein each of the plurality of fasteners also fasten to the mounting base.

6. The electric motor and controller assembly of claim 1, wherein the controller mounting bracket comprises at least one bracket that presents a flat mounting surface for the heat sink portion of motor controller.

7. The electric motor and controller assembly of claim 6, wherein the at least one bracket extends from a compartment cover that attaches over an open end of the motor end cap.

8. The electric motor and controller assembly of claim 1, further comprising a compartment cover having a central hole through which the second end of the motor shaft passes, the compartment cover comprising a plurality of arms extending radially away from the central hole and beyond an outer circumference of the motor end cap.

9. The electric motor and controller assembly of claim 8, further comprising a fan shroud covering over the fan, the fan shroud removably attached to one or more of the plurality of arms of the compartment cover.

10. The electric motor and controller assembly of claim 9, further comprising a bridge spanning between two of the plurality of arms of the compartment cover, the bridge forming at least a portion of the controller mounting bracket.

11. The electric motor and controller assembly of claim 1, further comprising an electrical compartment extending from the motor end cap, wherein the electrical connector extends from the motor controller to the electrical compartment.

12. The electric motor and controller assembly of claim 11, wherein the electrical connector extends no more than ninety degrees around an outer circumference of the electric motor assembly.

13. An electric motor and controller assembly, comprising:
an electric motor assembly including a mounting base joined to a motor end cap, the motor end cap comprising a compartment with an opening facing away from the mounting base;
a compartment cover attached to the motor end cap to seal the compartment;
a motor output shaft having a first end extending through the mounting base and a second end extending through the compartment cover;
a fan mounted on the second end of the motor output shaft;
a fan shroud attached to the compartment cover;
a controller mounting bracket mounted on the electric motor assembly; and
a motor controller mounted on the controller mounting bracket;
wherein the fan operates to cool the electric motor assembly and the motor controller during operation of the electric motor and controller assembly.

14. The electric motor and controller assembly of claim 13, further comprising:
an electrical compartment extending from a side of the electric motor assembly, and
an electrical connector extending from the motor controller to the electrical compartment.

15. The electric motor and controller assembly of claim 14, wherein the electrical connector extends no more than ninety degrees around an outer circumference of the electric motor assembly.

16. An electric motor and controller assembly comprising:
an electric motor positioned between a motor mounting base and a motor end cap, the motor end cap having a cylindrical outer surface;
an electrical compartment presenting an electrical connector facing away from the motor end cap;
a controller mounting bracket comprising a mounting platform and a mounting arm, wherein the mounting platform provides a flat surface for mounting a controller, and wherein the mounting arm extends perpendicularly away from the flat surface to connect with the motor end cap;
a motor controller mounted to the flat surface of the mounting platform; and
an electrical cable extending from the motor controller and having a mating end for connection to the electrical connector.

17. The electric motor and controller assembly of claim 16, wherein the mounting arm has a curved mounting surface configured to align with and wrap around at least a portion of the cylindrical outer surface of the motor end cap.

18. The electric motor and controller assembly of claim 16, wherein the electrical cable has a total length that is less than a length around the cylindrical outer surface of the motor end cap.

19. The electrical motor and controller assembly of claim 16, further comprising:
a motor output shaft extending through the electric motor and having a first end and a second end;
a fan connected to and rotatable with the first end of the motor output shaft; and
a fan shroud that coves over the fan.

20. The electric motor and controller assembly of claim 19, further comprising a compartment cover that fits over an open end of the motor end cap and presents a plurality of arms that extend beyond the cylindrical outer surface of the motor end cap to receive locking tabs of the fan shroud to hold the fan shroud in place over the fan.

21. The electric motor and controller assembly of claim 1, wherein the motor controller comprises a heat sink portion and the controller mounting bracket serves to place the heat sink portion in the airflow.
